(19) United States
(12) Patent Application Publication
(10) Pub. No.: US 2011/0318457 A1
(43) Pub. Date: Dec. 29, 2011

(54) Pet Meal Kit

(76) Inventor: Zaneta Lynn Daniel, Houston, TX (US)

(21) Appl. No.: 12/824,197

(22) Filed: Jun. 27, 2010

(51) Int. Cl. B65D 81/32; A23K 1/18

(52) U.S. Cl. 426/115

(57) ABSTRACT

The meal kit container of the present invention contains a disposable package which an animal can be feed by using a complete ready-to-use animal meal kit that can be disposed of after use. The invention comprises a meal kit whose components consist of a heat sealed locking closure pouch sufficient to store dry animal food, a locking closure pouch sufficient to hold water and a heat sealed pouch sufficient to hold an edible animal cookie or similar animal treat.

### FIELD OF INVENTION

The present invention relates to a mobile disposable travel container kit for a pet animal such as cats or dogs. The water and food are provided in the correct proportions, so that nourishment can be provided to the pet while in transit or in the home.

### BACKGROUND OF THE INVENTION

Increasingly pet owners spend the day in transit with their pets, travel extended distances with their pets, enjoy time at the park with their animals and other activities that would require the need and convince of a portable disposable animal feeding kit. Currently, there are portable pet feeding devices; however, none provide a complete ready to use meal kit for your pet that can be purchased, immediately used and subsequently disposed of. Separately purchasing food, water, and a container can be costly, and it is time consuming for the owner to mix everything on their own. There are commercially available meal kits for humans. However, the present invention is a novel meal kit for pets including dogs, cats and other animals.

### SUMMARY OF THE INVENTION

The container of the present invention contains a disposable package which an animal can be feed by using a complete ready-to-use animal meal kit that can be disposed of after use. The invention comprises a meal kit whose components consist of a heat sealed locking closure pouch sufficient to store dry animal food, a locking closure pouch sufficient to hold water and a heat sealed pouch sufficient to hold an edible animal cookie or similar animal treat. These components contain a predefined quantity of pet food and drinking water which upon mixing becomes a predefined meal for a pet dog or cat. The said components of the ready to use animal meal kit are placed in a compartmentalized food package, which is suitable and intended for use in feeding the animal.

### BRIEF DESCRIPTION OF THE DRAWINGS

Other features and advantages of the present invention will become apparent from the following detailed description of the preferred embodiment when read in conjunction with the following drawings of which:

FIG. 1 illustrates a perspective view of the ready to use animal meal kit of the present invention with the components of the kit in compartments.

FIG. 2 illustrates a perspective of the ready to use animal meal kit from an exploded perspective view of the present invention.

FIG. 3 illustrates a top plan perspective view of the animal meal kit of the present invention.

FIG. 4 illustrates a side elevation view of the animal meal kit of the present invention with the components stored within the container.

FIG. 5 illustrates a top plan view of one embodiment of the container without the meal components.

FIG. 6 illustrates an exploded view of an alternative embodiment of the present invention.

FIG. 7 illustrates the container with a re-sealable lid.

### DESCRIPTION OF PREFERRED EMBODIMENT

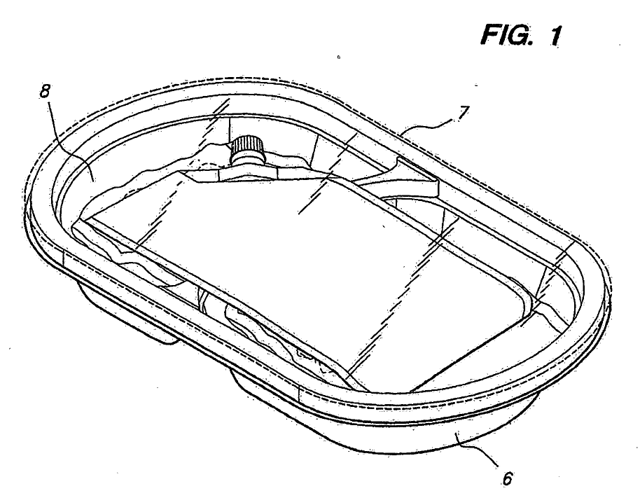

Referring to FIGS. 1-5, there is shown one embodiment of the present invention. The disposable package in the form of a meal kit is generally illustrated in FIG. 1. In the illustrated embodiment in FIG. 4, the animal food package (7) comprises a container (6) segmented into a plurality of compartments (9, 10) with each having a deep reservoir (20, 21). Compartment (9) has a flat bottom (30) with side walls (32, 34) extending upward therefrom to top edge of perimeter (40) and compartment (10) has a flat bottom (31) with side walls (33, 36) extending upward therefrom to top edge of perimeter (40). The present invention can be implemented with more than two compartments.

The animal food package 7 is designed to store a desired pet food and supply of water with each in a predetermined proportion for the desired pet animal. The size of the food package 7 is not critical to the present invention and may be obviously vary in size and/or proportion to accommodate the pet animal. Although oval shape in the illustrated embodiment, the overall shape of the container 6 and geometry of the opening of each compartment (9, 10) is not critical to the present invention.

In the illustrated embodiment, in use, one compartment can be used for water, and the other compartment can be used for food. The outer perimeter edge (40) of the container (6) is surrounded by a protruding rim (14) vacuum sealed with top (8) to preserve the inner meal components of travel food package (7).

The top (8) has a flat planar surface and is preferably made of a transparent flexible film or sheet material, which may be printed upon if, desired. The sheet is vacuum sealed airtight to the outer periphery of top edge (40). The top (8) fits over the protruding rim (14) securing and hermetically sealing the contents of the kit from the atmosphere. The internal compartments (9, 10) of the illustrated embodiment are separated by an internal median (45). In use, to open the container (6) the sealed top (8) is removed.

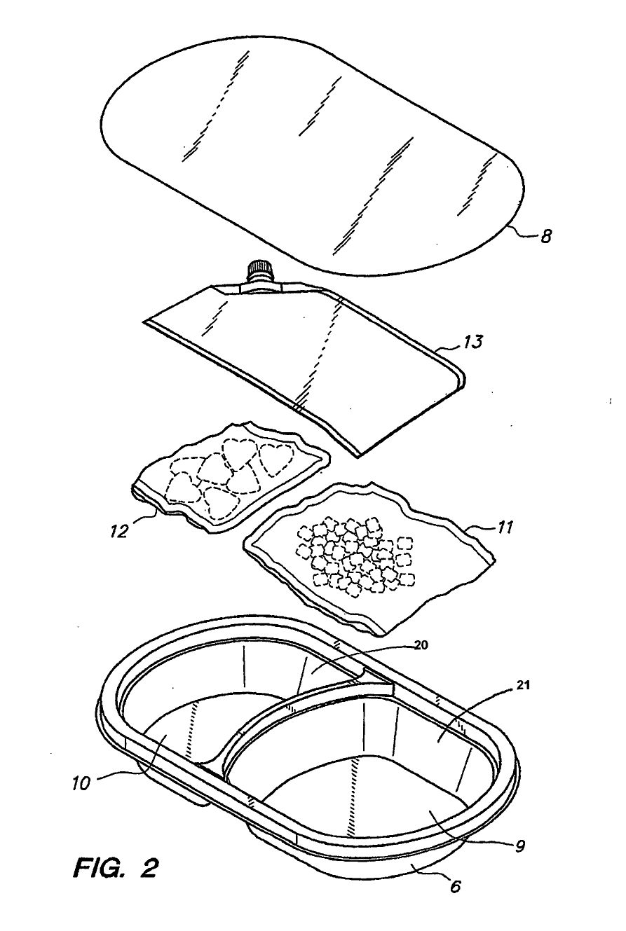

FIG. 2 is an exploded perspective view of the ready-to-use animal meal kit according to the invention. It further illustrates the rigid container (6) with recessed compartments (9, 10), top (8), and the inner components (11, 12, and 13) of the ready-to-use animal meal kit (7). The various components comprise a first vacuum sealed pouch of animal food (11), a second vacuum sealed closure pouch of water (13) and a third vacuum sealed pouch (12) containing an edible animal cookie, similar animal treat or another similar meal portion.

In use, compartment (9), which has a rectangular shaped portion in the illustrated embodiment, is intended to accommodate the animal food for storage and feeding. As further depicted compartment (10) which has a crescent shape in the depicted embodiment, is used to store the second meal portion or alternatively it can also be used to hold water for the animal to drink.

In the illustrated embodiment, the water pouch (13) is laid on top of the compartments (9, 10). The dimensional size of the meal pouches (11 and 12) should be less than the compartments (9, 10), so that meal pouches (11 and 12) can fit easily into the compartments (9, 10). Each meal pouch (11, 12) can be manufactured from a thin plastic material such as cellophane or another suitable material that can be easily torn for opening to retrieve the so that it may be opened. Additionally, meal pouch (11 and 12) can be adapted with a re-sealable locking mechanism (50, 52) such as the zip loc mechanism along the upper edge of the each pouch. Additionally, re-sealable water pouch (13) can be dimensioned slightly less than top edge 40 of container 6 so that fits snuggly below top film (8) above compartments (9, 10). A small utensil (54) can also be placed within the package to all for the user to prepare food that requires mixing.

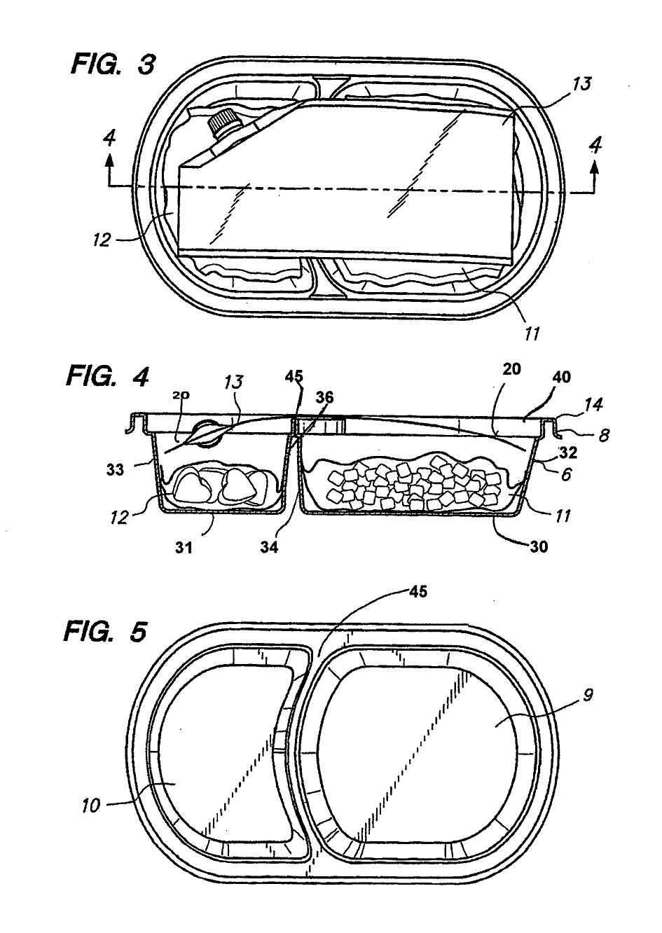

FIG. 3 is a top view of the animal meal kit and packaging illustrating the positioning and separation of components of the ready-to-use animal meal kit of the invention. FIG. 3 illustrates the positioning of the pouch with animal food 11 within compartment 9; the positioning of the edible animal cookie or similar animal treat 12 within the second compartment 10 and water pouch 13 is positioned horizontally overlaying both compartments (9, 10).

FIG. 4 illustrates a side view of the invention. It shows the positioning of the pouch with animal food (11), the pouch with the edible animal cookie or similar animal treat (12) and the water pouch (13); the separation of compartment (10) from compartment (9) and the positioning and sealing of top (8) to base (6). The disposable meal package (7) inner components can further comprise a utility pouch for storing supporting elements to care for the pet such as cat litter or urination pad for a dog or other suitable pet care elements.

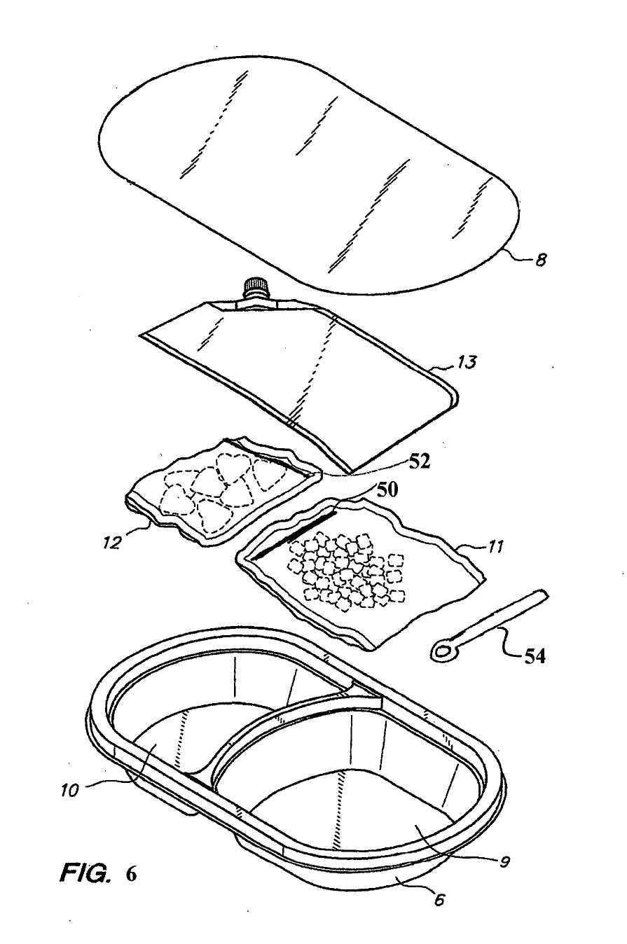

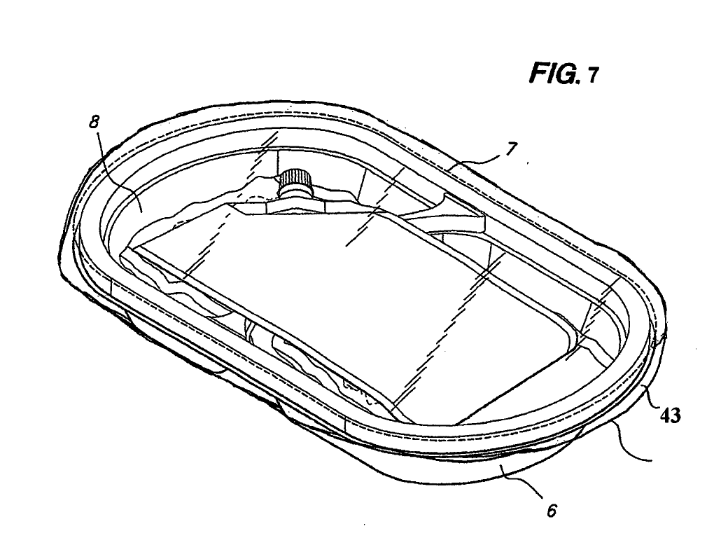

FIG. 5 is a top view of the container (6) and further illustrates the compartments (9, 10) respectively with deep reservoir (21, 20) situated between separation median (45). As shown in FIG. 2, each compartment has a flat bottom (30, 31), an internal side wall and an external side wall. While in use flat bottom (30, 31) provides support while the container (6) is placed upon a flat surface. The external side wall (33, 32) extends upward and is incorporated with top edge (40). The internal side wall (34, 36) extends upward and non-connected to its adjacent internal side wall (34, 36). The size of the container is not critical to the invention, so the size may vary. The variation of size allows for the accommodation of different size dogs, cats, and other animals.

What is claimed is:

1. A disposable meal package for a pet in the form of a kit comprising, in combination, an opened container formed with a plurality of internal compartments surrounded by a rim defined by a top peripheral edge;
each compartment having a flat bottom, an external side wall, and an internal side wall;
the flat bottom for supporting the container on a flat surface;
the external side wall extending upward to the top peripheral edge and incorporated therewith;
the internal side wall being non-connected to an adjacent internal side wall, extending upward to an internal median and being connected therewith;
internal components comprising a first food pouch and a water pouch;
the first food pouch being vacuumed sealed containing a predetermined portion of pet food and being dimensioned to fit within a compartment;
the water pouch being re-sealable and containing a predetermined portion of water for the pet;
the opening of each compartment forming a deep reservoir for containing water or food after the container is opened for use; and
a top flat flexible film vacuum sealed to the top peripheral edge wherein the internal components are preserved.

2. The disposable meal package of claim 1 the first food pouch and the water pouch are flexible and thin formed from a material composition selected from the group consisting of plastic, aluminum foil, or cellophane.

3. The disposable meal package of claim 1 further comprising a second food pouch that is dimensioned to fit within a second compartment and that is flexible and thin formed from a material composition selected from the group consisting of plastic, aluminum foil, or cellophane.

4. The disposable package of claim 1 wherein the internal components further comprises a small utensil for preparing food within a compartment.

5. The disposable meal package of claim 3 wherein the second food pouch has a re-sealable locking mechanism incorporated along a vacuum sealed upper edge.

6. The disposable meal package of claim 1 wherein the first food pouch has a re-sealable locking mechanism incorporated along a vacuum sealed upper edge.

7. The disposable meal package of claim 1 wherein the water pouch has a flat planar surface that is dimensioned to overlay the plurality of compartments and contained a predetermined portion of water.

8. The disposable meal package of claim 1 wherein the inner components further comprises a utility pouch for storing supporting elements to care for the pet.

9. The disposable meal package of claim 8 wherein the utility pouch has a re-sealable locking mechanism incorporated along a vacuum sealed upper edge.

10. The disposable meal package of claim 1 wherein the external side wall of one or more of each compartment extends upward at an obtuse angle.
